(19) United States
(12) Patent Application Publication
(10) Pub. No.: US 2006/0012604 A1
(43) Pub. Date: Jan. 19, 2006

(54) Legacy processing for pixel shader hardware

(76) Inventors: Avinash Seetharamaiah, Folsom, CA (US); Esen Yilmaz, Folsom, CA (US)

Correspondence Address: INTEL CORPORATION, P.O. BOX 5326, SANTA CLARA, CA, 95056-5326, US

(21) Appl. No.: 10/892,535

(22) Filed: Jul. 15, 2004

(51) Int. Cl. G09G 5/00; G06T 15/50; G06T 15/60

(52) U.S. Cl. 345/582; 345/426

(57) ABSTRACT

A method may include receiving texture information and determining whether a precompiled shader that corresponds to the texture information exists. A new shader may be compiled based on the texture information if the precompiled shader corresponding to the texture information does not exist. The precompiled shader may be used if the precompiled shader corresponding to the texture information exists.

### BACKGROUND

Implementations of the claimed invention generally may relate to processing graphical images and, more particularly, to processing graphical images that involve legacy texture units.

In graphics processing, textures have been applied or “mapped” to geometric primitives (e.g., triangles) in an image. In the past, such texture mapping has involved so-called “fixed functions” that were determined by various combination of hardware texture units. For example, a fixed function may involve one or more texture units that implement various texture environments, with or without additional hardware units for color summing, fog addition, stippling, etc. In this manner, various fixed processing functions were built into graphics hardware, and graphics software applications relied on the presence of such fixed functions.

More recently, graphics hardware has become programmable on-the-fly to implement, among other things, fixed functions implemented by previous non-programmable graphics hardware. Such programmable hardware may emulate (or otherwise implement the functionality of) the texture units (e.g., now termed “legacy” texture units) that contribute to the legacy fixed functions. Graphics processors may compile new fixed functions (e.g., pixel shaders) as they are needed. Graphics software applications, however, may still use legacy application programming interfaces (APIs) that correspond to the legacy fixed functions. Such software applications also may change texture environments relatively often, forcing re-computation of fixed functions (e.g., pixel shaders) with each change.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system; and

FIG. 2 is a flow chart illustrating processing of graphics data.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

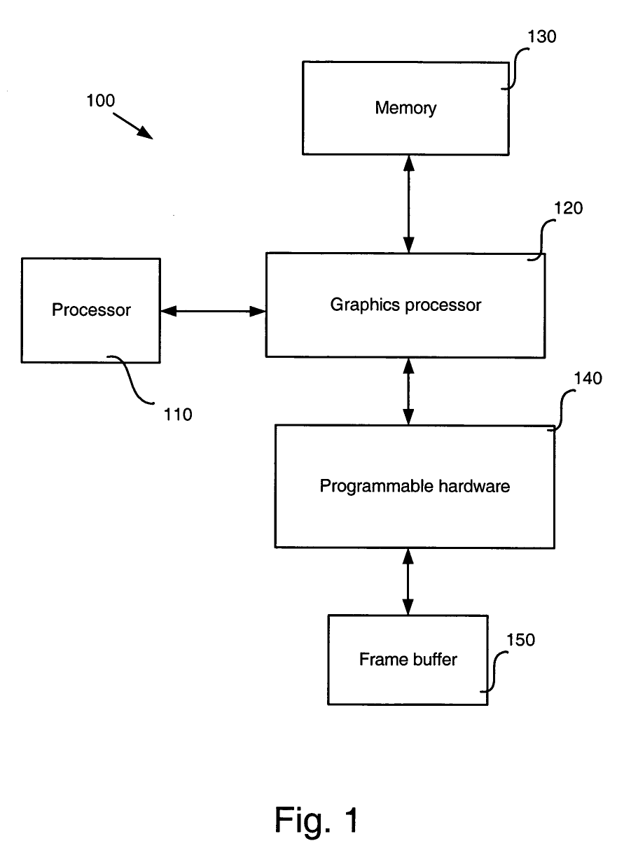

FIG. 1 illustrates an example system 100. System 100 may include a processor 110, a graphics processor 120, a graphics memory 130, programmable hardware 140, and a frame buffer 150. In some implementations, one or more of elements 120-150 may be included in a physically distinct graphics card that is connected to processor 110 via a data bus. In some implementations, elements 120-150 may be located on a common circuit board (e.g., a motherboard, daughter card, etc.) with element 110. In some implementations, one or more of elements 120-150 may be part of one portion (e.g., a core) of a device, and processor 110 may be include in another portion (e.g., another core) of the same device.

Processor 110 may include a general-purpose processor, a specific-purpose processor, and/or logic configured for a specific purpose. Processor 110 may be arranged to distribute graphics data (e.g., a state vector) to graphics processor 120 via a data bus. Processor 110 may send the graphics data under control of a program, such as a rendering, game, graphical creation, or other type of graphics-related program. In some implementations, processor 110 may send the graphics information using an application programming interface (API), such as a legacy graphics API. The graphics information may include, for example, a texture environment, geometry data, etc.

Graphics processor 120 may include a general-purpose processor, a specific-purpose processor, and/or logic configured for a specific purpose. Graphics processor 120 may be arranged to receive graphics data from processor 110 and to convert the graphics data into a program (e.g., a pixel shader) to be executed by programmable hardware 140. In some cases, graphics processor 120 may compile the program using primarily the graphics data received from processor 110.

In some cases, graphics processor 120 may use the received graphics information to look up and re-use a precompiled program (e.g., a pixel shader) stored in graphics memory 130. In such cases, graphics processor 120 may generate a signature or other index from the received graphics data to aid in rapidly finding such precompiled program in memory 130. The operation of graphics processor 120 in the context of generating new programs or using already generated programs will be further described below.

Graphics memory 130 may include a storage device to store graphics data. Graphics memory 130 may include a random access memory (RAM) device, such as a dynamic RAM (DRAM), double data rate RAM (DDR RAM), etc. Although illustrated as connected to graphics processor, in some implementations graphics memory 130 may also be connected (or at least directly readable/writable to/by) one or more of processor 110 and programmable hardware 140.

Graphics memory 130 may receive and store graphics data and/or programs from processor 110 and graphics processor 120. In addition to storing graphics data, graphics memory 130 may also store an index and/or signature list associated with such graphics data and/or programs to enable a rapid check for the presence of a particular piece of information (e.g., a particular pixel shader program).

Programmable hardware 140 may be arranged to perform certain graphical rendering operations on graphical data based on a received program (e.g., a pixel shader). Such operations may be performed on rasterized graphical data, and may include some combination of texturing, color summing, fog addition, stippling, etc. Programmable hardware 140 may receive such programs, for example, to perform legacy fixed functions, from graphics processor 120. In some implementations, programmable hardware 140 may receive an address of a program in memory 130, and it may read the program directly from memory 130.

Frame buffer 150 may be arranged to receive processed data from programmable hardware 140 and buffer it, if necessary, prior to display. Frame buffer 150 may also output data to a display or display interface, possibly under control of graphics processor 120. The associated display (not shown) may include a television, monitor, projector, or other device suitable for displaying graphical information, such as video and/or graphics. Such a display may utilize a number of technologies for such displaying, including cathode ray tube (CRT), liquid crystal display (LCD), plasma, and/or projection-type technologies.

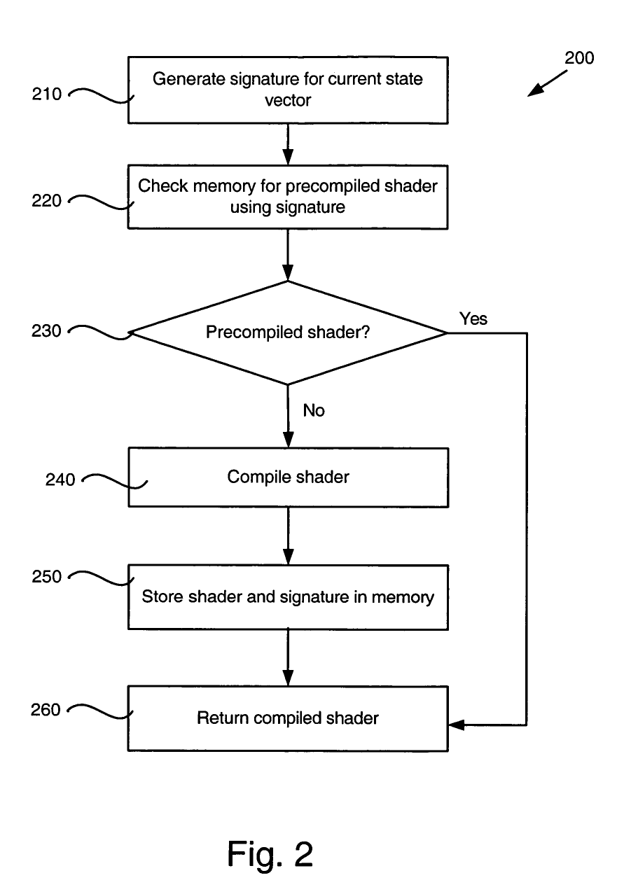

FIG. 2 is a flow chart 200 illustrating processing of graphics data. Although process 200 may be described with regard to system 100 for ease of explanation, the claimed invention is not necessarily limited in this regard. In some implementations, process 200 may be performed only when some aspect of the current texture environment is changed. In some implementations, process 200 may be performed only when a legacy API is used, and some aspect of the current texturing scheme changes.

Processing may begin with graphics processor 120 receiving graphics data, a state vector in some implementations, from processor 110. Graphics processor 120 may generate a signature for the received state vector [act 210]. In some implementations, this signature may be a shortened and/or compressed version of the state vector including, for example, texture environment(s), fog, color sum information, etc. This compressed state vector signature may include only several bytes per texture unit instead of many tens of bytes per texture for the state vector. In some implementations, the signature may be a hash, checksum, or another known identification scheme that is relatively quick to generate for a given piece of graphics data. Such hashing may be performed by graphics processor 120 on either the state vector or a compressed version thereof.

Processing may continue with graphics processor 120 checking memory 130 for an existing signature that matches the signature generated in act 210 [act220]. The presence of an existing signature in memory 130 may indicate that a precompiled program (e.g., pixel shader) that corresponds to the received state vector is available in memory 130.

In the case where no signature match (and hence no precompiled shader) is found [act 230], graphics processor 120 may compile a pixel shader program corresponding to the received state vector [act 240]. Such a new pixel shader may correspond to a legacy fixed function that has not previously occurred in a given graphics application.

As such, graphics processor 120 may store the new pixel shader in graphics memory 130 for possible re-use at a later time [act 250]. In act 250, graphics processor may also store the associated signature generated in act 210 so that the new pixel shader may be found in a later act 220.

Processing may conclude with graphics processor 120 returning the pixel shader to programmable hardware 140 for further processing [act 260]. In some implementations (e.g., if act 250 has already been performed), processor 120 may send an address of the shader in memory 130 to programmable hardware 140. Programmable hardware 140 may then execute the program at that address when appropriate. In some implementations, processor 120 may send the pixel shader program directly to programmable hardware 140, perhaps allowing acts 250 and 260 to be concurrently performed.

Returning to act 220, in the case where a matching signature (and an appropriate precompiled shader) is found in memory 130 [act 230], graphics processor 120 may return the precompiled pixel shader to programmable hardware 140 for further processing [act 260]. Such a precompiled pixel shader may correspond to a legacy fixed function that has previously occurred in a given graphics application, and which may be re-used. Such re-use of pixel shaders may avoid resource use to recompile the previously encountered pixel shader upon every change in texture environment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although the shader re-use scheme described herein has been described primarily with regard to legacy APIs, such a scheme may also be used with any number and combination of graphics APIs to avoid unnecessary re-compilation.

Moreover, the acts in FIG. 2 need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method, comprising:
receiving texture information;
determining whether a precompiled shader that corresponds to the texture information exists;
compiling a new shader based on the texture information if the precompiled shader corresponding to the texture information does not exist; and
using the precompiled shader if the precompiled shader corresponding to the texture information exists.

2. The method of claim 1, wherein the determining includes:
generating a signature associated with the texture information, and
checking whether the signature is already stored in a memory.

3. The method of claim 2, further comprising:
storing the signature and the new shader if the checking determines that the signature is not already stored in the memory.

4. The method of claim 2, wherein the generating includes:
compressing the texture information to generate the signature.

5. The method of claim 1, wherein the texture information is included in an application programming interface (API).

6. A system, comprising:
a memory to store texturing programs;
programmable hardware to execute texturing programs; and
a processor to receive texture information, to check the memory for a texturing program corresponding to the texture information, and to direct the programmable hardware to the texturing program corresponding to the texture information if the texturing program corresponding to the texture information is found in the memory.

7. The system of claim 6, wherein the processor is arranged to compile the texture information into a new texturing program if the texturing program corresponding to the texture information is not found in the memory.

8. The system of claim 7, wherein the processor is further arranged to store the new texturing program in the memory and to direct the programmable hardware to the new texturing program.

9. The system of claim 8, wherein the processor is further arranged generate a signature corresponding to the new texturing program and to store the signature in the memory.

10. The system of claim 6, wherein the processor is arranged to generate a signature from the texture information and to use the signature to check the memory for the texturing program corresponding to the texture information.

11. The system of claim 6, further comprising:
another processor to send the texture information in an application programming interface (API) to the processor.

12. A machine-accessible medium including instructions that, when executed, cause a machine to:
generate a signature from a received graphics application programming interface (API);
determine whether a memory contains a pixel shader program corresponding to the graphics API based on the signature;
instruct programmable hardware to execute the pixel shader program corresponding to the graphics API if the memory contains the pixel shader program; and
compile a new pixel shader program based on the graphics API if the memory does not contain the pixel shader program corresponding to the graphics API.

13. The machine-accessible medium of claim 12, further including instructions that, when executed, cause the machine to:
store the new pixel shader program in the memory.

14. The machine-accessible medium of claim 12, further including instructions that, when executed, cause the machine to:
instruct the programmable hardware to execute the new pixel shader program if the memory does not contain the pixel shader program corresponding to the graphics API.

15. A method, comprising:
receiving a new texture environment;
generating a new signature corresponding to the new texture environment;
checking a memory for a stored signature corresponding to the new signature; and
programming hardware with a stored pixel shader corresponding to the stored signature if the memory contains the stored signature.

16. The method of claim 15, further comprising:
generating a new pixel shader corresponding to the new texture environment if the memory does not contain the stored signature.

17. The method of claim 16, further comprising:
storing the new pixel shader and the new signature in the memory.

18. The method of claim 16, further comprising:
programming the hardware with the new pixel shader.
